(19) United States
(12) Patent Application Publication
(10) Pub. No.: US 2024/0271716 A1
(43) Pub. Date: Aug. 15, 2024

(54) Valve Actuator

(71) Applicant: GEA Tuchenhagen GmbH, Büchen (DE)

(72) Inventors: Wolfgang Arnold, Großerlach (DE); Jens Burmester, Grambek (DE)

(21) Appl. No.: 18/565,399

(22) PCT Filed: May 31, 2022
(86) PCT No.: PCT/EP2022/064809

§ 371 Date: Nov. 29, 2023

(30) Foreign Application Priority Data
Jun. 1, 2021 (DE) 10 2021 002 817.1

(51) Int. Cl. F16K 31/06; F16K 31/08

(52) U.S. Cl. CPC F16K 31/0655; F16K 31/082; F16K 31/088

(57) ABSTRACT

A valve actuator can be connected to a valve and can be operatively connected to a closing element of the valve. To create a valve actuator that is favorable in terms of purchase and maintenance, it is proposed that a spiral-shaped first magnet arrangement interacts with an outer second magnet arrangement that can be moved about a longitudinal axis of the spiral-shaped first magnet arrangement and that can be coupled with the closing element and is guided in a guiding element. The guiding element, together with a rotational movement of the second magnet arrangement, effects a rotary lifting movement of the first magnet arrangement.

### TECHNICAL FIELD

The invention relates to a valve actuator that can be connected to a valve and that can be operatively connected to a closing element of the valve.

### BACKGROUND

Various valves, in particular globe values, including double seat valves, are used in processing systems for the production of food products, beverages, medicines, and fine chemical products, as well as in biotechnology. Pipe diameters of ten centimeters and more are in use here. At the same time, high hygienic and sometimes aseptic properties of the process components are demanded, for example, leak-tightness and cleanability.

For decades, pneumatic valve actuators have been used to displace the closing elements of such valves. These have a piston to which compressed air is applied. The piston can be spring-loaded in a movement direction. However, there are also valve actuators in which compressed air is applied to the piston for movement in each of its movement directions.

Increasingly, compressed air is provided in processing systems only for the valves. This is costly in terms of purchase and maintenance.

Other valve actuators have been proposed, for example, in WO 2016/102367 A1. Until now, although they have been brought to the market, they have not been able to establish themselves in the applications mentioned above.

### SUMMARY

It is therefore an object of this disclosure to create a valve actuator that is favorable in terms of purchase and maintenance.

The object is achieved by a valve actuator having the features and advantageous developments described herein.

A valve actuator that can be connected to a valve and that can be operatively connected to a closing element of the valve is improved in that a spiral-shaped first magnet arrangement interacts with an outer second magnet arrangement that can be moved about a longitudinal axis of the spiral-shaped first magnet arrangement, that can be coupled with the closing element and is guided in a guiding element. The guiding element, together with a rotational movement of the second magnet arrangement, affects a rotary lifting movement of the first magnet arrangement.

This embodiment of a valve actuator allows a pressure medium of, for example, a pneumatic type to be dispensed with. Electric current can be used, which is more cost-effective in new construction and in ongoing operation.

The guiding element can be a pair of dome-like elevations that are provided on a running surface for the spiral-shaped magnet arrangement. This creates degrees of freedom in the design of the spiral and has only a small amount of friction between the moving elements due to a small contact area. Alternatively, the guiding element can be a spiral-like groove or a groove portion, which is advantageous for the transmission of force.

The first magnet arrangement can comprise a spiral. This allows the movement speed of the plunger to be set to a value that is favorable for the application by the slope of the magnet arrangement. In addition, necessary strength of the magnetic coupling between the first and second magnet arrangements can be created. In this case, the use of magnet material, for example, can be kept low when a flat slope of the spiral is chosen.

The spiral can be embodied with a hollow rod in which permanent magnets are accommodated, for example, sphere magnets. This reduces the costs of production, for example, through simplified assembly.

The second magnet arrangement is moved about the longitudinal axis on a path. This movement can be generated pneumatically or hydraulically. Preferably, however, this movement is generated by an electric motor to be able to dispense with pressure medium throughout.

The closing element can comprise a hollow rod, in which a rod of a second closing element is accommodated in a shiftable manner and completely passes through the hollow rod. While the hollow rod interacts with the already defined magnet arrangements, the rod can form an operative complex with additional magnet arrangements, preferably according to the structural principle of the first two magnet arrangements. This allows a double seat valve with two closing elements to be created.

Yet another embodiment intends to improve the magnetic coupling between the magnet arrangements. The first magnet arrangement comprises at least two sphere magnets, between which a non-magnetic steel sphere is arranged and the magnetization of which is aligned to a radial direction. This leads to a close coupling of the sphere magnets to the second magnet arrangement. This can comprise multiple magnets, wherein each of these magnets can be arranged, seen radially, on a line with a sphere magnet.

According to another solution, which effects an improvement of the magnetic coupling between the magnet arrangements, the first magnet arrangement comprises at least two permanent magnets, the magnetization of which is oppositely poled in relation to each other and is aligned to a radial direction. The at least two permanent magnets are connected to each other with a field conductor. As a result, a horseshoe-shaped magnet arrangement is formed, which couples to the second magnet arrangement. A closed magnetic circuit can be formed, whereby the coupling becomes stronger.

Changes to the second magnet arrangement are also suitable for improving the magnetic coupling between the magnet arrangements. A positive effect was thus achieved in that the second magnet arrangement comprises at least two magnets that are magnetically oppositely aligned to each other so that the magnetic north pole and the magnetic south pole are approximately opposite each other.

The movement of the second magnet arrangement on a circular path about the axis A, also referred to as rotation in the following, that is necessary for the movement of the plunger is effected by a magnet displacement device, which can be designed manually, hydraulically, pneumatically, or by an electric motor. In an advantageous embodiment, the movement is generated in that the magnet displacement device comprises an electric coil, the magnetic field of which can be brought into an operative connection with the magnetic field of the second magnet arrangement. By changing the supply of current to the coil, its influence on the second magnet arrangement changes, to which the second magnet arrangement responds with a mechanical movement. The selection of the number of electric coils, their distribution around the circular path, and the extension over the circumference of the housing of the process component allow the triggered movement of the second magnet arrangement to be precisely tailored to the necessities resulting from the field of application of the process component.

The advantages of the valve actuator according to one demonstrated embodiment can be applied particularly well in a valve arrangement with a valve for hygienic and aseptic applications and a valve actuator because no pressure medium needs to be supplied to these sensitive areas. The electric cabling that is already present simply can be supplemented. Processing systems for the production of food products, beverages, medicines, and fine chemical products, as well as in biotechnology, in which various valves, in particular globe valves including double seat valves, are used, become more cost-effective. Moreover, their hygienic or aseptic properties are improved.

The valve arrangement is further improved when the valve actuator comprises an actuator rod and a coupling is provided that connects a closing element of the valve to the actuator rod. This simplifies assembly. The coupling can be embodied in this case to permit a twisting of the actuator rod and the closing element against each other and to transmit an axial force. In this case, for example, a solution as demonstrated in EP 3271623 B1 can be used. An impairment of the function of the valve arrangement arising from the opposing introduction of torques is thereby reduced.

According to another improvement of the valve arrangement, the closing element can pass through a housing feedthrough. This creates a cost-effective modular design consisting of the valve and valve actuator, in which an interior of the valve is securely separated from the surroundings.

The invention will be described, and the advantages thereof explained in more detail, based on an example and its development.

### BRIEF DESCRIPTION OF THE DRAWINGS

FIG. 1 is a schematic and partial sectional view of an arrangement with a valve and a valve actuator.

FIG. 2 is a schematic section through a valve actuator in a first embodiment.

FIG. 3 is a longitudinal section through a spiral-shaped magnet arrangement.

FIG. 4 is a schematic section through a valve actuator in a development of the first embodiment.

FIG. 5 is a section along the line I-I′ from FIG. 4.

FIG. 6 is a schematic representation of the magnet arrangements and their magnetization.

FIG. 7 is a schematic representation of the magnet arrangements and their magnetization in a first development.

FIG. 8 is a schematic representation of the magnet arrangements and their magnetization in a second development.

### DETAILED DESCRIPTION

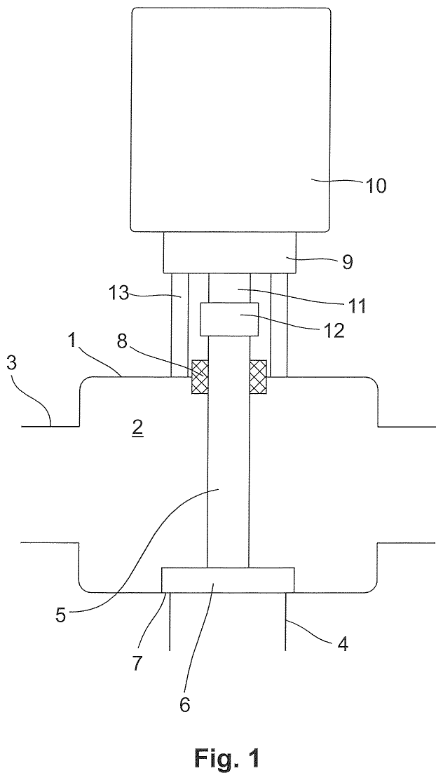

FIG. 1 schematically shows a section through a valve with a valve housing 1. The valve housing 1 surrounds an interior 2. The valve comprises a first connection 3 and a second connection 4. The connections 3 and 4 can be connected to a pipe or a container of a processing system. The connections 3 and 4 are fluidically connected to the interior 2 and to each other by this interior 2.

The fluid connection of the connections 3 and 4 can be switched with a closing element 5. This can comprise a closing body 6, which is designed, for example, in the shape of a plate. The closing body 6 can be brought into sealing contact with a valve seat 7.

The closing element 5 passes through a housing feedthrough 8 so that a part of the closing element 5 is located outside of the interior 2 and the valve housing 1. The housing feedthrough 8 acts here in a sealing manner and can additionally have a guiding and/or bearing function.

A housing coupling 9 creates a mechanical connection of the valve to the valve actuator 10. The valve actuator 10 is operatively connected to the control element 5. The valve actuator 10 can comprise an actuator rod 11. A coupling 12 establishes a mechanical and preferably detachable connection, which is designed for the transmission of force, of the control element 5 and actuator rod 11. This coupling 12 can be designed to be decoupled upon rotation, as is taught in EP 3271623 B1. With a coupling 12 that is decoupled upon rotation, torques occurring in the valve actuator 10 are prevented from being transmitted to the closing element 5 and vice versa. This reduces, among other things, the wear on the component.

Between the coupling 12 and the valve housing 1, a so-called lantern 13 can be provided. The lantern 13 creates a distance between the housing 1 and the valve actuator 10 and makes the coupling 12 accessible. The lantern can in turn be detachably fastened to the housing 1, for example, by a flange or screw connection.

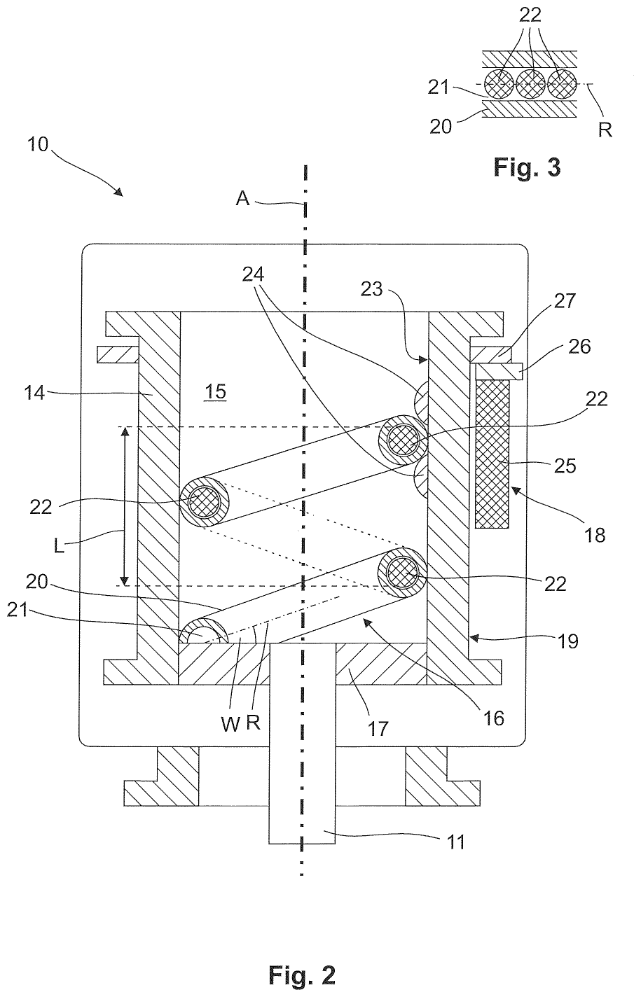

FIG. 2 shows a simplified representation of a longitudinal section through the valve actuator 10.

The valve actuator 10 comprises a sleeve 14 extending along the longitudinal axis A with a sleeve interior 15. A first magnet arrangement 16 is accommodated in the sleeve interior 15. The first magnet arrangement 16 can be connected to a transition body 17, which is in turn connected to the actuator rod 11 so that a transmission of force from the first magnet arrangement 16 to the actuator rod 11 can take place and a movement of the first magnet arrangement 16 along the longitudinal axis A effects a movement of the actuator rod 11 along the longitudinal axis A. Instead of the actuator rod 11, the transition body 17 can be formed for directly connecting to the closing element 5. This can then replace the coupling 12. The sleeve 14 and the transition body 17 can be formed as one part.

The first magnet arrangement 16 is magnetically coupled with a second magnet arrangement 18, which is located on an outer side 19 of the sleeve 14.

The first magnet arrangement 16 extends in the direction of the longitudinal axis A over a length L that is sufficient for the desired stroke of the closing element 5. Sufficient means that, in each position of the plunger 5 along its stroke H, a magnetic coupling with the second magnet arrangement 18 that has enough force to withstand fluid pressure is provided.

In the presented example, the first magnet arrangement 16 has the shape of a spiral 20, which extends from the transition body 17 into the sleeve interior 15 along the longitudinal axis A. A long magnet can be arranged along the spiral 20. Advantageously, the first magnet arrangement 16 has a plurality of permanent magnets located in a hollow space 21 of the spiral 20 embodied as a tube. The tube is preferably manufactured from a non-magnetic stainless steel and has a round cross-section. The permanent magnets can be embodied as sphere magnets 22, which simplifies the manufacturing of the spiral tube filled with magnets. This embodiment is illustrated in FIG. 3 with a section along an axis R of the tube. An angle W between the axis of the tube R and a plane to which the longitudinal axis A is perpendicular defines a slope of the spiral 20.

The sleeve 14 has an inner side 23 facing the interior 15. On the inner side 23, at least one guiding element 24 is arranged, in which the first magnet arrangement 16 is guided. The guiding element 24 can comprise two spherical cutout-like domes, between which the spiral 20 runs in a slidingly shiftable manner. The guiding element 24 is designed so that the shift can only take place at an angle to the longitudinal axis A. The spiral 20 and the sleeve 14 are dimensioned such that the spiral 20 is braced on the inner side 23 to prevent it from tilting about the longitudinal axis A. The guiding element 24 can also be formed as a circumferential, spiral-shaped furrow on the inner side 23 of the sleeve 14 or from a combination of indentations and elevations on the inner side 23 that fulfill the guiding function described here. The design of the sleeve 14 is tailored to its function, which is primarily carrying the guiding element 24. Furthermore, the sleeve 14 can have the function of guiding the spiral 20.

The second magnet arrangement 18 on the outer side 19 of the sleeve 14 comprises at least one magnet 25. The second magnet arrangement 18 extends over a part of a circumference about the longitudinal axis A. The magnet 25 is carried by a magnet holder 26. The magnet holder 26 is rotatably supported by a magnet displacement device 27. The magnet displacement device 27 is configured for a movement of the magnet 25 about the sleeve 14 and the longitudinal axis A. This rotary movement is effected by an actuator (not shown), which can be operated manually, hydraulically, pneumatically, or by an electric motor. Preferably, to obtain a good magnet coupling of the first magnet arrangement 16 and the second magnet arrangement 18, the second magnet arrangement 18, in the example shown as the magnet 25, extends in the direction of the longitudinal axis A at a height of a spiral winding of the spiral 20.

The switching process of the valve can be seen when viewing FIG. 1 and FIG. 2 together. The closing element 5 is brought out of the closed position according to FIG. 1 into an open position in that the magnet 25 rotates once about the longitudinal axis A. Due to the magnetic coupling with the sphere magnet 22 arranged firmly in the hollow space 21, the sphere magnet 22 initially follows the magnet 25. Due to the spiral shape of the first magnet arrangement 16 in interaction with the guiding element 24, the sphere magnet 22 is shifted relative to the magnet 25 along the longitudinal axis A. At the same time, the spiral 20 and with it the first magnet arrangement 16 also rotates about the longitudinal axis A. In the further course of the path movement of the magnet 25 in its rotation about the longitudinal axis A, the spiral 20 is rotated like a screw in a thread. The magnetic coupling to the magnet 25 jumps from one sphere magnet 22 to its adjacent sphere magnet 22. One circulation of the magnet 25 about the longitudinal axis A and the sleeve 14 causes one rotation of the spiral. Due to the guiding element 24, the spiral 20 executes this screwing movement and is shifted by the height of the length L of the spiral 20. This shift results in the movement of the closing element by the stroke.

The closing movement, which brings the closing element 5 back into the position according to FIG. 1, is effected by a circling of the magnet 25 about the longitudinal axis A that is opposite to the circling described. The actuator and the magnet displacement device 27 are accordingly designed to execute this movement.

The spiral 20 can be prevented from tilting out of the direction of the longitudinal axis A in that more than the length L of the first magnet arrangement 16 remains in operative contact with the inner side 23. In the example of the spiral 20, this is more than one spiral pass.

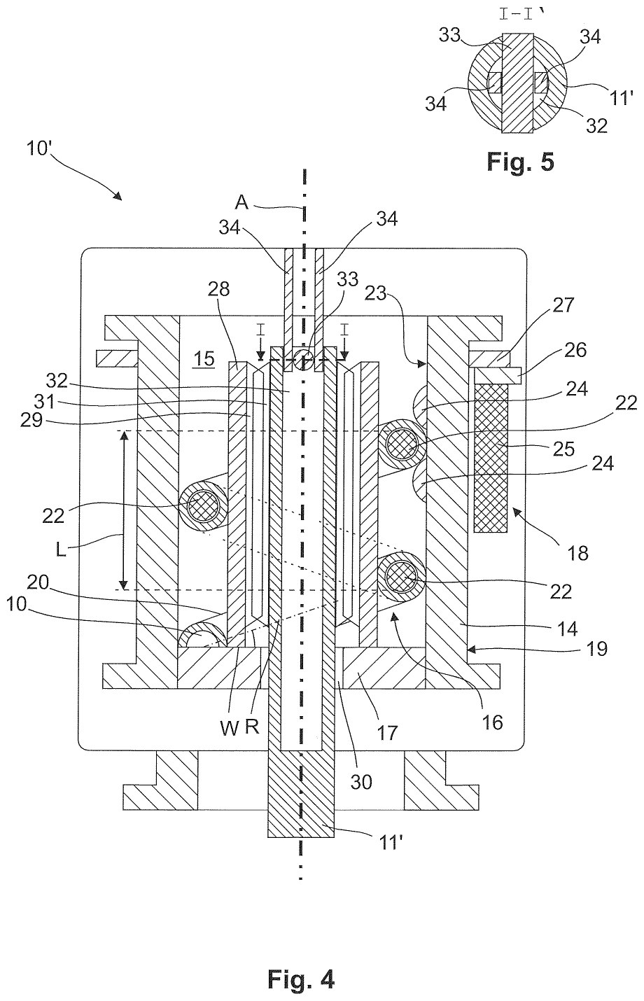

FIG. 4 and FIG. 5 show a development of the valve actuator 10. The valve actuator 10′ according to the development differs from the valve actuator 10 according to FIG. 2 in that the first magnet arrangement 16 acts on the actuator rod 11′ indirectly.

Therefore, in this development, the spiral 20 and the actuator rod 11′ are not directly rigidly connected to each other. Instead, the spiral 20 is connected indirectly or directly rigidly to an intermediate body 28. This intermediate body 28 can be designed in the shape of a cylinder with a longitudinal axis that is aligned to the longitudinal axis A. The intermediate body 28 is hollow and has an internal thread 29. The spiral 20 and the intermediate body 28 can be embodied as one component, which is produced, for example, in a three-dimensional printing method.

The actuator rod 11′ passes through an opening 30 in the transition body 17, which in the representation according to FIG. 4 connects the spiral 20 to the intermediate body 28. The transition body 17, however, can be dispensed with when the spiral 20 and the intermediate body 28 are directly rigidly connected to each other. The actuator rod 11′ is inserted into the intermediate body 28 and has a rod portion with an external thread 31 that engages with the internal thread 29.

The actuator rod 11′ is accommodated in the valve actuator 10′ in a manner that is secured against twisting. An advantageously simple solution is shown in FIG. 4. On a side facing away from the closing element, the actuator rod 11′ has a cutout 32 that is embodied, for example, as a bore.

A transverse pin 33 passes through the cutout 32 transversely to an extension direction of the actuator rod 11′.

In the valve actuator 10′, at least one guide arm 34, which is inserted into the cutout 32 and is located between a wall of the cutout 32 and the transverse pin 33, is immovably provided. Two guide arms 34 can also be provided, between which the transverse pin 33 is arranged in a shiftable manner. Together with the transverse pin 33, the guide arm 34 prevents the actuator rod 11′ from being able to rotate about the longitudinal axis A.

One rotation of the second magnet arrangement 18, in the example shown the magnet 25, about the longitudinal axis A also effects here, as described with reference to FIG. 2 and FIG. 3, a shift of the first magnet arrangement 16 along the longitudinal axis A. This means at the same time a shift of the intermediate body 28 along the longitudinal axis A. Due to the engagement of the internal thread 29 and the external thread 31 in conjunction with the rotation prevention, in the form of the transverse pin 33 and the guide arm 34, an indirect shift of the actuator rod 11′ along the longitudinal axis A takes place. The extent of this shift of the actuator rod 11′ now depends on the ratio of the slopes of the pairing of internal thread 29 and external thread 31 to the slope of the spiral 20. The internal thread 29 and the external thread 31 act as a transmission ratio for the shifting length along the longitudinal axis A and thus also of the control force that can be exerted on the closing element 5 with the actuator rod 11′.

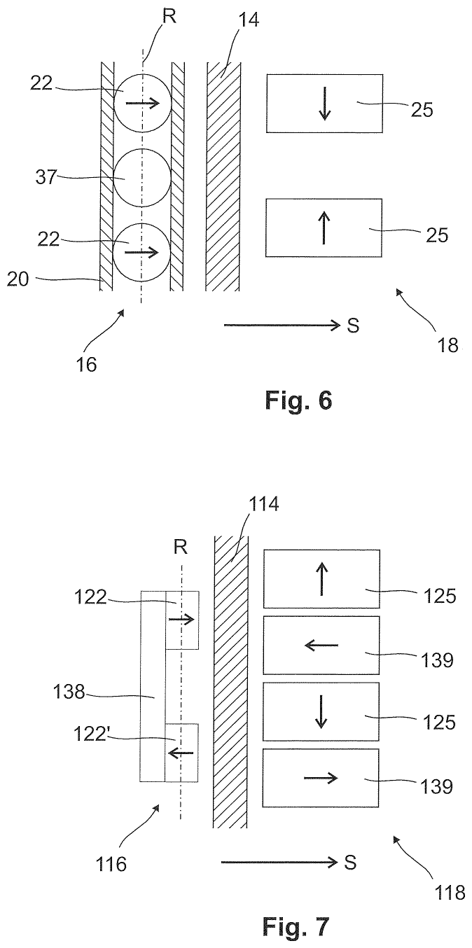

FIG. 6 shows a part of the first magnet arrangement 16 and the second magnet arrangement 18 in a schematic representation.

The magnet arrangements 16 and 8 are spatially separated from each other by the sleeve 14. However, they are operatively connected to each other through magnetic forces. The alignment of the magnetization of the permanent magnets of the magnet arrangements 16 and 18 are illustrated with arrows. To transmit force, the magnetic fields of the permanent magnets of both magnet arrangements 16 and 18 must interact with each other. It has been shown that a particularly good transmission of force via the fields is achieved when the magnetization of the sphere magnets 22 of the first magnet arrangement 16 is aligned along a radial direction S that is perpendicular to the longitudinal axis A. During this, the magnetization of the magnets 25 of the second magnet arrangement 18 is aligned to a direction perpendicular to the radial direction S. Magnets 25 that are respectively adjacent to each other in a circumferential direction about the longitudinal axis L are aligned magnetically opposite to each other such that the magnetic north pole and the magnetic south pole are approximately opposite each other. The sphere magnets 22 and the magnets 25 can be magnetized perpendicularly to each other. Furthermore, an improvement of the magnetic coupling has been shown in that a magnetically neutral distance element, for example, a non-magnetic steel sphere 37, is arranged between each two adjacent sphere magnets 22. The extension of the one-part or multipart distance element along the axis R is dimensioned so that sphere magnets 22 of the first magnet arrangement 16 and magnets 25 of the second magnet arrangement 18 are assigned in pairs, for example, are opposite each other, and can be arranged on a line in the radial direction S. A particularly good magnetic coupling is thereby effected.

One development of the magnetic arrangements 16 and 18 is schematically shown in FIG. 7, in which arrows also symbolize the alignment of the magnets.

The coupling between the magnet arrangements 116 and 118 is improved in that the magnetization direction is chosen as shown.

The first magnet arrangement 116 has at least two permanent magnets 122, the magnetization of which is aligned to the radial direction S, but opposite. While in the case of a permanent magnet 122 the magnetic south pole lies radially to the inside and the magnetic north pole lies radially to the outside, in the adjacent permanent magnets 122′ it is exactly the other way around. On the radially inner side of the permanent magnets 122 and 122′ and thus facing away from the sleeve 114, two adjacent permanent magnets 122 and 122′ are connected to each other with a magnetically conducting field conductor 138.

In addition to the magnetized magnets 125 described previously in FIG. 6, the second magnet arrangement 118 also has guide magnets 139. Each guide magnet 139 is arranged between two magnets 125. While the magnetization of the magnets 125 is angled in relation to the radial direction S as previously described, for example, approximately at a right angle, the magnetization of the guide magnets 139 is aligned to the radial direction S. As shown in FIG. 7, the magnetization of four adjacent magnets 125 and guide magnets 139 can be turned by a right angle so that the fifth following magnet or guide magnet again has the magnetization direction of the first. In the example, the magnetization rotates in an axis perpendicular to the plane of the paper and counterclockwise when the sequence of magnets 125 and guide magnets 139 is viewed from top to bottom in FIG. 7.

In this embodiment, an improved magnetic coupling between the magnet arrangements 116 and 118 results when one permanent magnet 122, 122′ of the first magnet arrangement 116 and one magnet 125 of the second magnet arrangement 118 can each be brought onto a line along the radial direction S and are therefore opposite each other. The distance between adjacent permanent magnets 122, 122′ and the extension of the field conductor along the direction R are chosen accordingly.

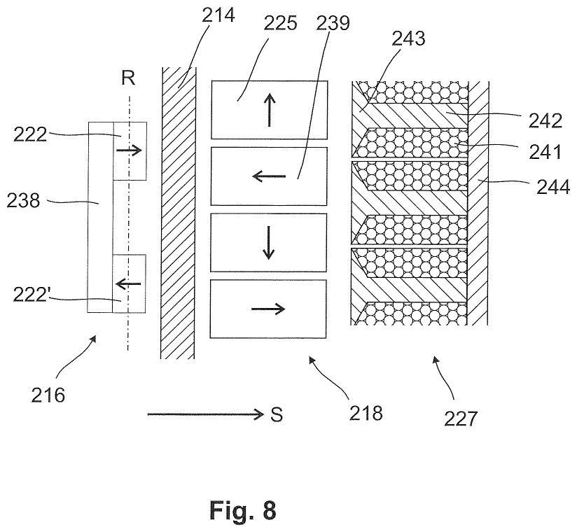

Another development is schematically shown in FIG. 8. This development relates to the magnet displacement device 227, with which the second magnet arrangement 218 is moved around the sleeve 214. In this development, the movement of the second magnet arrangement 218 takes place with the aid of a coil arrangement. The coil arrangement surrounds the sleeve 214 and a movement path of the second magnet arrangement 218 at least in portions in the circumferential direction. The coil arrangement comprises an electric coil 241, the magnetic field of which is aligned to the radial direction S, for example, parallel to the radial direction S. The electric coil 241 preferably has a coil core 242 for field bundling and a pole 243 facing the second magnet arrangement 218. A yoke 244 is arranged on a side of the coil core 242 opposite the pole 243. This yoke 244 guides the magnetic field and closes a magnetic circuit that is formed between the electric coil 241 and the magnets 225 and 239 of the second magnet arrangement 218. By arranging multiple electric coils 241 along the movement path of the second magnet arrangement 218 and switching the supply of electricity, the second magnet arrangement 218 couples to alternating coils 241 and is thus carried along and moved mechanically.

The second magnet arrangement 218 can have magnets 225 and guide magnets 239, as in the example according to FIG. 7. The first magnet arrangement can be embodied according to one of the exemplary embodiments shown according to FIG. 1 to FIG. 7 and can have oppositely poled permanent magnets 222 and 222′ and field conductor 238.

The following is a list of reference signs used in this specification and in the drawings.
1 Valve housing
2 Interior
3 First connection
4 Second connection
5 Closing element
6 Closing body
7 Valve seat
8 Housing feedthrough
9 Housing coupling
10, 10′ Valve actuator
11, 11′ Actuator rod
12 Coupling
13 Lantern
14, 114, 214 Sleeve
15 Sleeve interior
16; 116; 216 First magnet arrangement
17 Transition body
18; 118; 218 Second magnet arrangement
19 Outer side
20 Spiral
21 Hollow space
22, 122, 122′, 222, 222′ Sphere magnet
23 Inner side
24 Guiding element
25, 125, 225 Magnet
26 Magnet holder
27; 227 Magnet displacement device
28 Intermediate body
29 Internal thread
30 Opening
31 External thread
32 Cutout
33 Transverse pin
34 Guide arm
37 Steel sphere
138, 238 Field conductor
139 Guide magnets
241 Electric coil
242 Coil core
243 Pole
244 Yoke
A Longitudinal axis
L Length
W Angle
R Axis of the tube
S Radial direction

1. A valve actuator that can be connected to a valve and that can be operatively connected to a closing element of the valve, comprising:
a first magnet arrangement that and is spiral-shaped and interacts with an outer second magnet arrangement, wherein the outer second magnet arrangement can be moved about a longitudinal axis of the spiral-shaped first magnet arrangement, can be coupled to the closing element, and is guided in a guiding element, and wherein the guiding element, together with a rotational movement of the second magnet arrangement, effects a rotary lifting movement of the first magnet arrangement.

2. The valve actuator according to claim 1, wherein the first magnet arrangement is arranged on an intermediate body with an internal thread, in which an external thread of a rod portion is accommodated, and wherein the first magnet arrangement can be coupled indirectly to the closing element via the rod portion.

3. The valve actuator according to claim 1, wherein the first magnet arrangement comprises a spiral with at least one permanent magnet.

4. The valve actuator according to claim 1, wherein the first magnet arrangement comprises at least two sphere magnets, between which a non-magnetic steel sphere is arranged and the magnetization of which is aligned to a radial direction.

5. The valve actuator according to claim 1, wherein the first magnet arrangement comprises at least two permanent magnets, the magnetization of which is oppositely poled to each other and aligned to a radial direction, and wherein the at least two permanent magnets are connected to each other with a field conductor.

6. The valve actuator according to claim 1, wherein the second magnet arrangement comprises at least two magnets that are aligned magnetically opposite to each other so that the-a magnetic north pole and the-a magnetic south pole are approximately opposite each other.

7. The valve actuator according to claim 1, comprising:
a magnet displacement device that includes an electric coil, a magnetic field of which can be brought into an operative connection with a magnetic field of the second magnet arrangement.

8. A valve arrangement with a valve for hygienic and aseptic applications and a valve actuator according to claim 1.

9. The valve arrangement according to claim 8, wherein the valve actuator comprises an actuator rod and the valve arrangement comprises:
a coupling that connects the closing element of the valve to the actuator rod.

10. The valve arrangement according to claim 9, wherein the closing element passes through a housing feedthrough.

11. The valve actuator according to claim 2, wherein the first magnet arrangement comprises a spiral with at least one permanent magnet.

12. The valve actuator according to claim 2, wherein the first magnet arrangement comprises at least two sphere magnets, between which a non-magnetic steel sphere is arranged and the magnetization of which is aligned to a radial direction.

13. The valve actuator according to claim 2, wherein the first magnet arrangement comprises at least two permanent magnets, the magnetization of which is oppositely poled to each other and aligned to a radial direction, and wherein the at least two permanent magnets are connected to each other with a field conductor.

14. The valve actuator according to claim 2, wherein the second magnet arrangement comprises at least two magnets that are aligned magnetically opposite to each other so that a magnetic north pole and a magnetic south pole are approximately opposite each other.

15. The valve actuator according to claim 2, comprising:
a magnet displacement device that includes an electric coil, a magnetic field of which can be brought into an operative connection with a magnetic field of the second magnet arrangement.

16. The valve actuator according to claim 3, wherein the first magnet arrangement comprises at least two sphere magnets, between which a non-magnetic steel sphere is arranged and the magnetization of which is aligned to a radial direction.

17. The valve actuator according to claim 3, wherein the first magnet arrangement comprises at least two permanent magnets, the magnetization of which is oppositely poled to each other and aligned to a radial direction, and wherein the at least two permanent magnets are connected to each other with a field conductor.

18. The valve actuator according to claim 3, wherein the second magnet arrangement comprises at least two magnets that are aligned magnetically opposite to each other so that a magnetic north pole and a magnetic south pole are approximately opposite each other.

19. The valve actuator according to claim 3, comprising:
a magnet displacement device that includes an electric coil, a magnetic field of which can be brought into an operative connection with a magnetic field of the second magnet arrangement.

20. The valve actuator according to claim 4, wherein the first magnet arrangement comprises at least two permanent magnets, the magnetization of which is oppositely poled to each other and aligned to a radial direction, and wherein the at least two permanent magnets are connected to each other with a field conductor.
